(19) United States
(12) Patent Application Publication
(10) Pub. No.: US 2019/0110508 A1
(43) Pub. Date: Apr. 18, 2019

(54) NUT BASED LIQUID CREAMERS AND METHOD OF MAKING THEREOF

(71) Applicant: NESTEC S.A., Vevey (CH)

(72) Inventors: Matthew Galen Bunce, Glen Burnie, MD (US); Maxime Saffon, Dublin, OH (US); Jun-Tse Ray Fu, Dublin, OH (US); Alexander A. Sher, Dublin, OH (US)

(21) Appl. No.: 16/086,389

(22) PCT Filed: Mar. 21, 2017
(86) PCT No.: PCT/EP2017/056746

§ 371 Date: Sep. 19, 2018

Related U.S. Application Data
(60) Provisional application No. 62/311,796, filed on Mar. 22, 2016.
(60) Provisional application No. 62/411,925, filed on Oct. 24, 2016.

(51) Int. Cl. A23L 9/20; A23L 2/60; A23L 2/66; A23L 29/269; A23L 29/25; A23L 29/238

(52) U.S. Cl. CPC A23L 9/24; A23V 2200/14; A23L 2/66; A23L 29/272; A23L 29/25; A23L 29/238; A23V 2002/00; A23V 2250/5022; A23V 2250/5054; A23V 2250/506; A23V 2250/5036; A23V 2250/548; A23V 2300/24; A23V 2250/628; A23V 2250/61; A23V 2250/606; A23V 2200/212; A23V 2250/15; A23V 2300/26; A23L 2/60

(57) ABSTRACT

The present invention relates to beverage products, in particular a liquid natural plant-based creamer composition comprising: an edible nut; high-acyl gellan gum present in an amount ranging from 0.08 to 0.15 wt/wt %; pea protein present in an amount ranging from 0.2 to 1 wt/wt %; and buffer.

### FIELD OF THE INVENTION

The present invention relates to liquid creamers and the method to produce the same. More specifically, the present disclosure is directed to creamers with natural hydrocolloids. Such creamer provides indulgent texture and mouthfeel when added to beverages such coffee or tea.

### BACKGROUND OF THE INVENTION

Creamers are widely used as whitening agents with hot and cold beverages such as, for example, coffee, cocoa, tea, etc. They are commonly used in place of milk and/or dairy cream.

Recent trends indicate that more and more consumers are seeking for dairy alternatives. For example, consumers consider plant-based creamers to whiten their cup. One drawback to consider while developing such creamers is that plant proteins often tend to give an off-flavor to the final beverage constituting the creamer.

Creamers may come in a variety of different flavors and provide mouthfeel, body, and a smoother texture. Creamers can be in liquid or powder forms. A liquid creamer may be intended for storage at ambient temperatures or under refrigeration, and should be stable during storage without phase separation, creaming, gelation and sedimentation. The creamer should also retain a constant viscosity over time. When added to cold or hot beverages such a coffee or tea, the creamer should dissolve rapidly, provide a good whitening capacity, and remain stable with no feathering and/or sedimentation while providing a superior taste and mouthfeel. Mouthfeel, also denoted richness, texture or creaminess, is usually provided by the oil emulsion present in the creamer.

Thus, it is critical not only to enhance texture/mouthfeel of coffee with creamers but also to have stable liquid coffee creamers as is without compromising creamer stability over shelf life (at least 6 months at refrigeration and ambient temperatures for aseptic products).

All previous attempts to create plant-based liquid creamers have the following drawbacks:

High viscosity of liquid creamers result in poor pour-ability from the bottle;

Dripping-back liquid stream during pouring; and

Phase separation (gelation, serum formation) during shelf life

The present invention allows to solve the following problems:

poor emulsion stability of the Extended Shelf Life (ESL) creamers over shelf life (5 months, refrigeration); and
poor sensory characteristics of plant-based creamers (e.g. smoothness, body, bitterness, oxidized flavors)

Other solutions to stabilize emulsion in liquid creamers include addition of sodium caseinate which is not plant-based and thus cannot be considered as a natural ingredient. Similarly, mono or di glycerides as well as DATEM (diacetyl tartaric acid ester of mono- and diglycerides) are synthetic and are not considered as natural ingredients.

Thus, there are no solutions available for natural, stable liquid plant-based creamer

The present invention relates to non-dairy ESL aseptically packaged liquid creamers comprising natural stabilizing systems, and to the process of making thereof.

### SUMMARY OF THE INVENTION

In one aspect, the present invention relates to a liquid natural plant-based creamer composition comprising: an edible nut; high-acyl gellan gum present in an amount ranging from 0.08 to 0.15 wt/wt %, pea protein present in an amount ranging from 0.2 to 1 wt/wt % and buffer. In one embodiment of the present invention, pea protein comprises protein extracted from pea flour, for example yellow pea (Pisum sativum) using isoelectric precipitation. In another embodiment of the present invention, pea protein is separated from the pea flour using enzymatic process for example alpha amylases for starch hydrolysis.

In another embodiment of the present invention, yellow peas (Pisum sativum), are roasted between 110 and 160° C. between 1 and 5 minutes prior extraction from the pea flour using isoelectric precipitation and/or enzymatic process.

In one embodiment of the present invention, the creamer further comprises acacia senegal gum present in an amount ranging from 0 to 1.5 wt/wt %;

In another embodiment of the present invention, the creamer further comprises guar gum present in an amount ranging from 0 to 0.5 wt/wt %;

In another aspect, the present invention relates to the composition described above, wherein the nut is an edible nut in the form of a paste or a powder. In one embodiment of the present invention, the edible nut comprises hazelnut, walnut, macadamia, almond, cashew, peanut, chestnut, pistachios, pecan and combinations thereof.

In one embodiment, the creamer of the present composition further includes a pH buffer comprising sodium bicarbonate ranging from 0.1 to 0.4 wt/wt % of the creamer composition.

In another aspect, the present invention relates to the composition described above, wherein D[4,3] particle size of creamer ranging from 5 to 25 microns.

The creamers are easily dispersible in coffee, stable in hot and cold acidic environment, without feathering, breaking emulsion, de-oiling, flocculation, and sedimentation. When added to coffee or tea or other liquid products, the creamers provide improved mouthfeel, full body, smooth texture, and also a good flavor with no off-flavor notes developed during storage.

Advantageously and unexpectedly, a unique combination of hydrocolloids, edible nut, pea protein and buffer provided physical and chemical stability to the creamers, preferred texture/mouthfeel/smoothness, and pleasant taste when added in coffee. In addition, the creamers have a good physico-chemical stability during shelf life.

The ESL creamers are stable at refrigeration for at least 5 months.

Though the present invention discloses the coffee creamers, use of the creamers, it is not limited for only coffee applications. For example, the creamers can be also used for other beverages, such as tea or cocoa, or used with cereals or berries, creamers for soups, in many cooking applications.

The products of the invention present excellent organoleptic properties, in particular in terms of texture and mouthfeel even when very low levels of fat are used. Besides, the products of the invention show good stability and can therefore advantageously allow avoiding the use of non-natural additives.

Another aspect of the present invention relates to a process of preparing the creamer composition comprising:

dissolving the ingredients in hot water under agitation;

sterilizing the composition using ultra-high temperature (UHT) treatment;

homogenizing the composition at temperature ranging from 70-85 C; wherein homogenization performed before UHT treatment, after UHT treatment, or before and after UHT treatment; and

cooling and filing the creamer under aseptic conditions.

### BRIEF DESCRIPTION OF THE FIGURES

FIG. 1 shows Instability Index of the liquid creamers (A, B and D represents Examples 6, 7 and 8, respectively).

### DETAILED DESCRIPTION OF THE INVENTION

Further in the present context unless otherwise indicated % of a component means the % of weight based on the weight of the creamer composition, i.e. weight/weight %.

In one embodiment of the present invention, the creamer further comprises of vegetable oils ranges from 0 to 8 wt/wt % of the creamer composition.

For the best mouthfeel, and physico-chemical properties as such and when added to hot coffee, the creamer composition comprises between about 2% and about 11% oil. Preferably, the unsaturated oil comprises a vegetable oil selected from the group consisting of high oleic canola, high oleic soybean oil, high oleic sunflower, high oleic safflower, coconut oil or a combination thereof.

In another embodiment of the present invention, the creamer comprises of sugar comprising sucrose, glucose, fructose, contained in cane sugar, beet sugar, molasses and/or combinations ranging from 0-35% of the creamer composition. Non-limiting examples of the sugar source include beets, canes, honey, molasses, agave syrup, maple syrup, malt, rice, oat, pea, corn, tapioca, potato sugar cane juice, yacon syrup or a combination thereof.

In another embodiment of the present invention, the creamer comprises a sweetener in an amount of 0 to about 10% by weight of the composition. By “sweetener” it is to be understood a mixture of ingredients which imparts sweetness to the final product. These include natural plant derived nutritive and non-nutritive sweeteners such as stevia or monk fruit.

In one embodiment of the present invention, the creamer comprises oil-in-water emulsion.

A beverage composition comprises the creamer as described in the present invention wherein the beverage is a coffee beverage, a cocoa or chocolate beverage, a malted beverage, and/or ready-to-drink beverage.

A beverage according to the invention comprises the creamer as described in the present invention and may e.g. be in the form of liquid or liquid concentrate to be mixed with a suitable liquid, e.g. water or milk, before consumption, or a ready-to-drink beverage. By a ready-to-drink beverage is meant a beverage in liquid form ready to be consumed without further addition of liquid.

The Lumisizer (LUM, Germany) Model 611 was used to evaluate the stability against creaming. Lumisizer (LUM, Germany), is an instrument using light scattering detection under sample centrifugation. It is especially designed to assess different separation phenomena based on oil droplet creaming or particle sedimentation occurring in oil-in-water emulsions and dispersions. In the Lumisizer, the so-called STEP technology (Step and Time resolved Extinction Profiles) is used. The samples were measured without dilution and centrifugal forces were exerted up to 2 hours at 20° C. and 2300 g force. The transmission profiles of samples were taken every 20 sec.

From the raw transmission profiles, the integral of transmission over time is calculated and its slope (named an Instability Index) was used as a quantitative measure for emulsion instability against creaming. Separation graphs shows movements of the interface between the dispersed phase, i.e. the movement of emulsion layers, and the clear phase, as a function of time.

The difference in separation rates (Instability Index) between the samples allowed to assess relative stability of emulsions against creaming. The integral transmission (T) was plotted as a function of time (t), and the slope (ΔT/Δt) was calculated. A higher slope (Instability Index) indicates a faster separation and thus a less stable product.

The size of particles, expressed in microns for volume mean diameter D[4,3] of the cumulative distribution measured using Malvern Mastersizer 3000 (laser diffraction unit). Ultra-pure and gas free water was prepared using Honeywell water pressure reducer (maximum deionised water pressure: 1 bar) and ERMA water degasser (to reduce the dissolved air in the deionised water).

In one embodiment of the present invention, the mean D[4,3] particle size of the creamer ranges from 5 to 25 microns.

A ready-to-drink beverage of the present invention may be subjected to a heat treatment to increase the shelf life or the product, e.g. by retorting, UHT (Ultra High Temperature) treatment, HTST (High Temperature Short Time) pasteurization, batch pasteurization, or hot fill.

The product may additionally comprise of natural flavors and/or natural colorants. These are used in conventional amounts which can be optimized by routine testing for any particular product formulation.

### EXAMPLES

### Example 1

Liquid Creamers were Produced as Below.

A dry blend of sugar, sodium bicarbonate, high acyl gellan gum, acacia senegal gum, yellow pea protein, sea salt, natural flavors was prepared by mixing together 22.5 kg of sucrose with 0.3 kg of sodium bicarbonate, 0.1 kg of high acyl gellan, 0.6 kg of acacia senegal gum, 0.5 kg of pea protein produced by isolelectric precipitation from yellow pea flour, 0.1 kg of sea salt, 0.1 kg of natural flavors. The dry blend was added into 50 kg of hot water (˜75° C.) under high agitation.

Next, and after 5 minutes of mixing under continuous high agitation, 4.5 kg of almond paste were added into the tank under high agitation for 5 minutes. Additional water was added to adjust the total amount to 100 kg.

The liquid creamer was pre-homogenized at 130/30, pre-heated, UHT treated for 12 sec at 140° C., homogenized at 130/30 bar and cooled. The liquid creamer was aseptically filled into bottles. The resultant liquid creamer can be aseptically filled in any aseptic containers such as, for example, jars, jugs or pouches. The liquid creamer was stored 5 month at 4° C.

The physico-chemical stability and sensory of creamer and coffee beverages with added liquid creamer were judged by trained panelists. No phase separation (creaming, de-oiling, marbling, etc), gelation, and practically no viscosity changes were found during the storage.

It was surprisingly found that the liquid creamer has good appearance, mouth-feel, smooth texture and a good flavor without “off” taste. In addition, the creamer showed high whitening capacity when added to a coffee.

### Example 2

A liquid creamer was prepared as in Example 1 but using 0.1 kg of high acyl gellan gum, 0.1 kg of guar gum, and 0.5 kg of yellow pea protein produced from pea flour by isoelectric precipitation. The physico-chemical stability and sensory of creamer and coffee beverages with added liquid creamer were judged by trained panelists. No phase separation (for example creaming, de-oiling and/or marbling), gelation, and practically no viscosity changes were found during the storage.

### Example 3

A liquid creamer was prepared as in Example 1 but using 0.1 kg of high acyl gellan gum, 0.1 kg of guar gum, and 0.6 kg of acacia senegal gum. The physico-chemical stability and sensory of liquid creamer and coffee beverages with added liquid creamer were judged by trained panelists. After 1-month storage at 30° C., the sensory evaluation showed severe gelation in the bottle.

### Example 4

A liquid creamer was prepared as in Example 1 but using 0.1 kg of guar gum and 0.08 kg of carrageenan. The physico-chemical stability and sensory of liquid creamer and coffee beverages with added liquid creamer were judged by trained panelists. After 1-month storage at 4° C., the sensory evaluation showed unacceptable phase separation (syneresis, creaming) and gelation.

### Example 5

A liquid creamer was prepared as in Example 1 but using 0.4 kg of sunflower lecithin. The physico-chemical stability and sensory of liquid creamer and coffee beverages with added liquid creamer were judged by trained panelists. After 2-month storage at 4° C., the sensory evaluation showed unacceptable phase separation (syneresis, creaming).

### Example 6

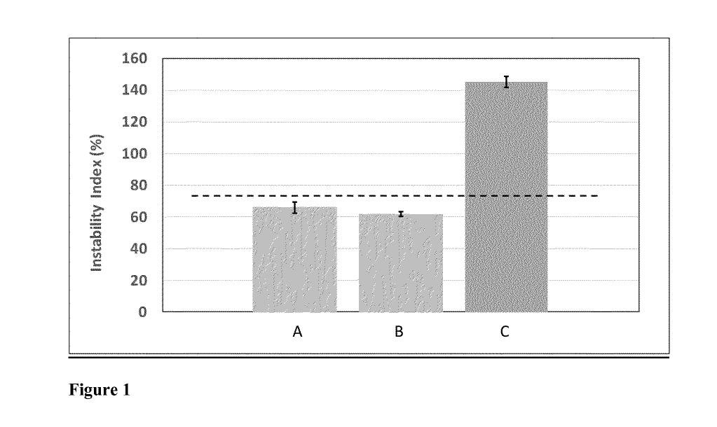

A liquid creamer was prepared as in Example 1 but using 6 kg of almond paste, 0.5 kg of pea protein produced by isoelectric precipitation of yellow pea flour, 0.1 kg of high-acyl gellan gum, and 0.1 kg of guar gum. The physico-chemical stability and sensory of creamer and coffee beverages with added liquid creamer were judged by trained panelists. No phase separation (creaming, de-oiling, and/or marbling), gelation, and practically no viscosity changes were found during the storage. It was surprisingly found that the liquid creamer has good appearance, mouth-feel, smooth texture and a good flavor without “off” taste. In addition, the creamer showed high whitening capacity when added to a coffee. Instability Index of the creamer is shown on FIG. 1, A.

### Example 7

A liquid creamer was prepared as in Example 1 but using 4.5 kg of almond paste, 3 kg of coconut oil, 0.5 kg of pea protein produced by isoelectric precipitation of yellow pea flour, 0.1 kg of high-acyl gellan gum, and 0.1 kg of guar gum. The physico-chemical stability and sensory of liquid creamer and coffee beverages with added liquid creamer were judged by trained panelists. The physico-chemical stability and sensory of creamer and coffee beverages with added liquid creamer were judged by trained panelists. No phase separation (for example creaming, de-oiling and/or marbling), gelation, and practically no viscosity changes were found during the storage. It was surprisingly found that the liquid creamer has good appearance, mouth-feel, smooth texture and a good flavor without “off” taste. In addition, the creamer showed high whitening capacity when added to a coffee. Instability Index of the creamer is shown on FIG. 1, B.

### Example 8

A liquid creamer was prepared as in Example 1 but using 4.5 kg of almond paste, 3 kg of coconut oil, 0.1 kg of high-acyl gellan gum, 0.1 kg of guar gum, and 0.6 kg of acacia senegal gum. The physico-chemical stability and sensory of liquid creamer and coffee beverages with added liquid creamer were judged by trained panelists. After 2-month storage at 20° C., the sensory evaluation showed unacceptable phase separation (syneresis, creaming). Instability Index of the creamer is high as shown on FIG. 1, C.

### Example 9

A liquid creamer was prepared as in Example 1 but using 6 kg of almond paste and 3 kg of coconut oil. The physico-chemical stability and sensory of liquid creamer and coffee beverages with added liquid creamer were judged by trained panelists. No phase separation (for example creaming, de-oiling and/or marbling), gelation, and practically no viscosity changes were found during the storage.

It was surprisingly found that the liquid creamer has good appearance, mouth-feel, smooth texture and a good flavor without “off” taste. In addition, the creamer showed high whitening capacity when added to a coffee.

### Example 10

A liquid creamer was prepared as in Example 1 but using 4.5 kg of almond paste, 3 kg of coconut oil, 0.1 kg of high-acyl gellan gum, 0.1 kg of guar gum, and 0.6 kg of acacia senegal gum.

The physico-chemical stability and sensory of liquid creamer and coffee beverages with added liquid creamer were judged by trained panelists. After 2-month storage at 20° C., the sensory evaluation showed unacceptable phase separation (syneresis, creaming).

### Example 11

A liquid creamer was prepared as in Example 2 but using 0.5 kg of pea protein produced from yellow pea flour by enzymatic hydrolysis. The physico-chemical stability and sensory of creamer and coffee beverages with added liquid creamer were judged by trained panelists. No phase separation (for example creaming, de-oiling and/or marbling), gelation, and practically no viscosity changes were found during the storage. The creamers obtained exhibited acceptable sensory properties.

1. A liquid natural plant based creamer composition comprising:
an edible nut;
high-acyl gellan gum present in an amount ranging from 0.08 to 0.15 wt/wt %;
pea protein present in an amount ranging from 0.2 to 1 wt/wt %; and
a buffer.

2. The composition of claim 1, wherein the nut is an edible nut in the form of a paste or a powder.

3. The composition of claim 1, comprising acacia senegal gum present in an amount ranging from 0 to 1.5 wt/wt %;

4. The composition of claim 1, comprising guar gum present in an amount ranging from 0 to 0.5 wt/wt %;

5. The composition of claim 2, wherein the edible nut is selected from the group consisting of hazelnut, walnut, almond, cashew, macadamia, peanut, chestnut, pistachios, pecan and combinations thereof.

6. The creamer of claim 1 wherein the composition comprises vegetable oils ranges from 0 to 8 wt/wt % of the creamer composition.

7. The creamer of claim 6 wherein the vegetable oils comprises a vegetable oil selected from the group consisting of coconut oil, high oleic canola, high oleic soybean oil, high oleic sunflower, high oleic safflower and combinations thereof.

8. The creamer of claim 1, further comprises a sugar selected from the group consisting of sucrose, glucose, fructose and combinations ranging from 0-35 wt/wt % of the creamer composition.

9. The creamer according to claim 1, comprising a natural sweetener in an amount of about 0 to about 10% by wt/wt % of the composition.

10. The creamer according to claim 1, further includes a pH buffer comprising sodium bicarbonate ranging from 0.1 to 0.4 wt/wt % of the creamer composition.

11. The creamer according to claim 1, wherein the mean D[4,3] particle size of the creamer ranges from 5 to 25 microns.

12. A beverage comprising water, a beverage-forming component and a sufficient amount of the creamer composition comprising an edible nut, high-acyl gellan gum present in an amount ranging from 0.08 to 0.15 wt/wt %, pea protein present in an amount ranging from 0.2 to 1 wt/wt %, and a buffer to provide whitening, good texture and mouthfeel.

13. The beverage of claim 12 wherein the beverage forming component is selected from the group consisting of coffee, tea, and chocolate.

14. A process of preparing the creamer composition comprising an edible nut; high-acyl gellan gum present in an amount ranging from 0.08 to 0.15 wt/wt %; pea protein present in an amount ranging from 0.2 to 1 wt/wt %; and a buffer comprising:
dissolving the ingredients in hot water under agitation;
sterilizing the composition using ultra-high temperature (UHT) treatment;
homogenizing the composition at temperature ranging from 70−85° C.; and
wherein homogenization performed before UHT treatment, after UHT treatment, or before and after UHT treatment.

15. The process of claim 14, wherein the pea protein is extracted from yellow pea (Pisum sativum) flour using isoelectric precipitation.

16. The process of claim 14, wherein the pea protein is extracted from yellow pea (Pisum sativum) flour using enzymatic processing.

17. The process of claim 14, wherein one of the ingredient is the yellow peas (Pisum sativum) and wherein the yellow peas are roasted prior to extraction from the yellow pea flour using isoelectric precipitation and enzymatic processing.
